(19) United States
(12) Patent Application Publication
(10) Pub. No.: US 2018/0343470 A1
(43) Pub. Date: Nov. 29, 2018

(54) METHOD OF USING CUBE MAPPING AND MAPPING METADATA FOR ENCODERS

(71) Applicant: Advanced Micro Devices, Inc., Sunnyvale, CA (US)

(72) Inventor: Michael L. Schmit, Sunnyvale, CA (US)

(73) Assignee: Advanced Micro Devices, Inc., Sunnyvale, CA (US)

(21) Appl. No.: 15/605,441

(22) Filed: May 25, 2017

(51) Int. Cl. H04N 19/593; G06T 9/00; H04N 19/46; G06T 3/00; H04N 5/92; H04N 13/00

(52) U.S. Cl. CPC H04N 19/593; G06T 9/00; H04N 13/0048; G06T 3/0087; H04N 5/9202; H04N 19/46

(57) ABSTRACT

Described herein is a method and apparatus for using cube mapping and mapping metadata with encoders. Video data, such as 360° video data, is sent by a capturing device to an application, such as video editing software, which generates cube mapped video data and mapping metadata from the 360° video data. An encoder then applies the mapping metadata to the cube mapped video data to minimize or eliminate search regions when performing motion estimation, minimize or eliminate neighbor regions when performing intra coding prediction and assign zero weights to edges having no relational meaning.

### BACKGROUND

360° or spherical videos are video recordings captured by an omnidirectional) (360° camera or a group of cameras configured for 360° coverage. Images from the many camera(s) are then stitched to form a single video in a projection space, such as equirectangular and spherical based spaces. This video data is then encoded for storage or transmission. However, encoding in equirectangular and spherical based spaces presents issues related to distortion. Moreover, encoders are typically configured to handle any type of video data. To do this, the encoder reads in all of the video data and stores it in a cache. The encoder searches though all of the video data to perform motion estimation and prediction coding. Consequently, the motion estimation searching and prediction processing are non-optimal because the image has been distorted to map the image into an equirectangular or other format from a true spherical shape.

### BRIEF DESCRIPTION OF THE DRAWINGS

A more detailed understanding can be had from the following description, given by way of example in conjunction with the accompanying drawings wherein:

FIG. 1 is an example system architecture that uses cube mapped video data and mapping metadata with encoders in accordance with certain implementations;

FIG. 2 is an example flow diagram for using cube mapped video data and mapping metadata in accordance with certain implementations;

FIG. 3 in an example diagram of unfolding a cube in a pixel arrangement in accordance with certain implementations;

FIG. 4 in another example diagram of unfolding a cube in another pixel arrangement accordance with certain implementations;

FIG. 5 in an example diagram of an encoder using cube mapped video data and mapping metadata in accordance with certain implementations;

FIGS. 6A-6C are examples of a motion estimation search region in an encoder and motion estimation search regions when using cube mapped video data and mapping metadata in accordance with certain implementations;

FIGS. 7A-7C are examples of impact on intra coding and in-loop filtering by using cube mapped video data and mapping metadata in accordance with certain implementations; and

FIG. 8 is a block diagram of an example device in which one or more disclosed implementations may be implemented.

### DETAILED DESCRIPTION

Described herein is a method and apparatus for using cube mapping and mapping metadata with encoders. Video data, such as 360° video data, is sent by a capturing device to an application, such as video editing software, which generates cube mapped video data and mapping metadata from the 360° video data. An encoder then applies the mapping metadata to the cube mapped video data to minimize or eliminate search regions when performing motion estimation, minimize or eliminate neighbor regions when performing intra coding prediction and assign zero weights to edges having no relational meaning. Consequently, the encoder encodes the cube mapped video data faster and more efficiently.

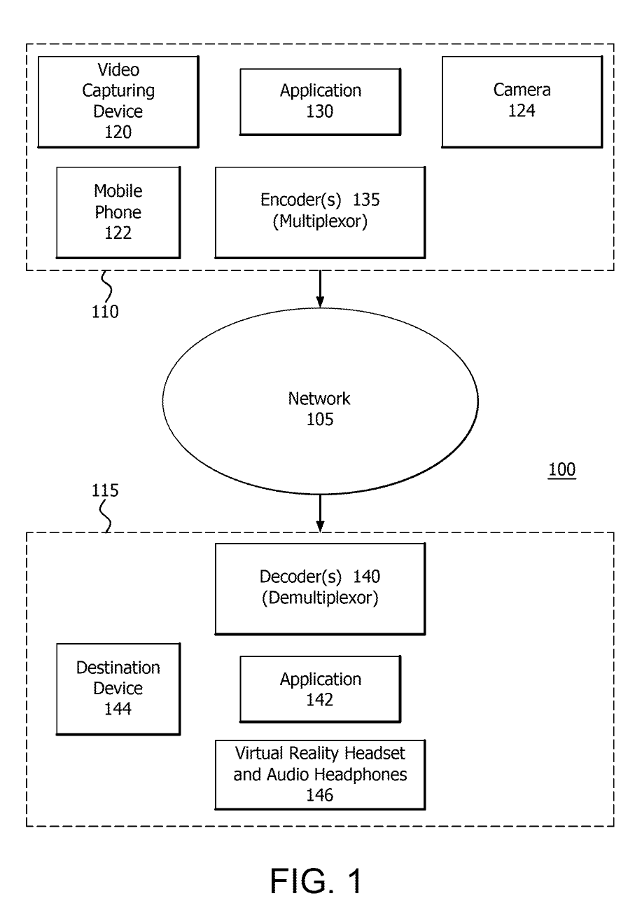

FIG. 1 is an example system 100 that uses cube mapped video data and mapping metadata with encoders to send encoded video data over a network 105, for example, from a source side 110 to a destination side 115, according to some embodiments. The source side 110 includes any device capable of capturing or generating video data, such as 360° video data, that may be transmitted to the destination side 115. The device may include, but is not limited to, a video capturing device 120, a mobile phone 122 or a camera 124. The video data from these devices is processed by an application 130 to create cube mapped video data and mapping metadata. The cube mapped video data is then processed by an encoder 135 using the mapping metadata as described herein below. The encoded video data and mapping metadata is then sent to decoder(s) 140 over network 105, for example, which in turn sends the decoded video data and mapping metadata to an application 142 for projecting the decoded cube mapped video data to a spherical space, for example. Application 142 then exports the video data to destination devices, which may include, but is not limited to, destination device 144, and virtual reality (VR) headset and audio headphones 146. The destination devices are illustrative and can include other platforms, for example, augmented reality devices and spherical displays such as a globe, (for viewing externally) or a dome, (for viewing internally).

Although encoder(s) 130 are shown as a separate device(s), it may be implemented as an external device or integrated in any device that may be used in capturing, generating or transmitting video data. In an implementation, encoder(s) 130 may include a multiplexor. In an implementation, encoder(s) 130 can process non-cube mapped video data as well as cube mapped data depending on the presence of the mapping metadata in, for example, the header information. Application 130 may be implemented or co-located with any of video capturing device 120, mobile phone 122, camera 124 or encoder(s) 135, for example. In an embodiment, application 130 may be implemented on a standalone server. Although decoder(s) 140 are shown as a separate device(s), it may be implemented as an external device or integrated in any device that may be used in replaying or displaying the video data. In an implementation, decoder(s) 140 may include a demultiplexor. In an implementation, decoder(s) 140 can process non-cube mapped video data as well as cube mapped data depending on the presence of the mapping metadata in, for example, the header information. Application 142 may be implemented or co-located with any of destination device 144, VII headset and audio headphones 146 or decoder(s) 140, for example.

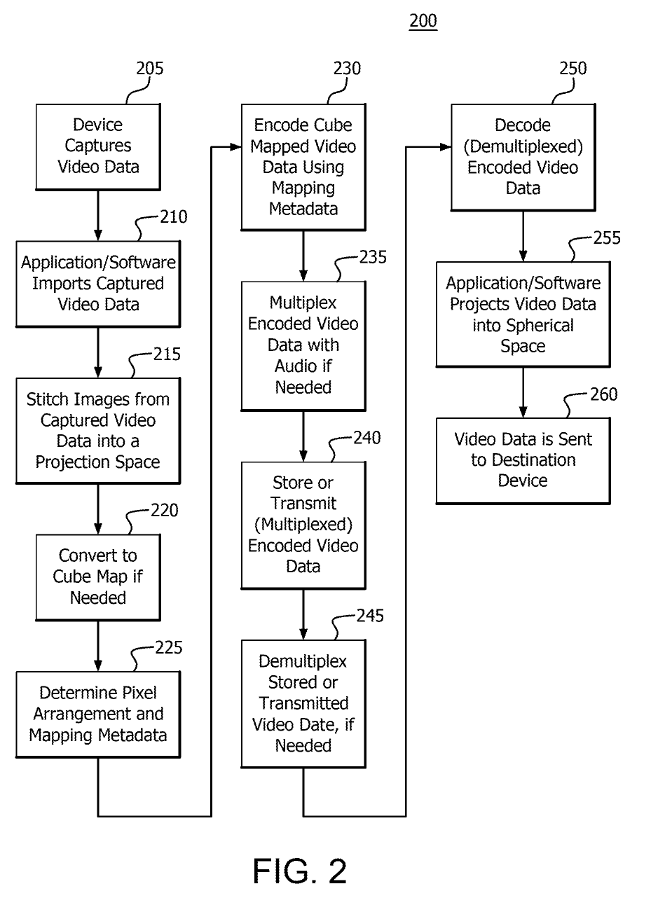

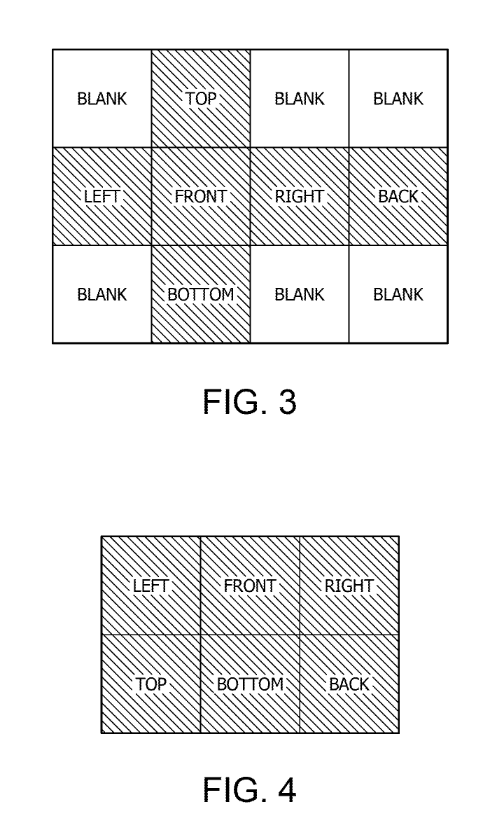

FIG. 2 is an example flow diagram 200 for using cube mapped video data and mapping metadata in accordance with certain implementations. The flow diagram 200 is described using the system of FIG. 1 for purposes of illustration. A video capturing device, such as video capturing device 120, a mobile phone 122 or a camera 124, is used to shoot and capture video data, such as 360° video data (205). The captured video data is imported by an application 130, video editing software or similar functionality (210) that stitches the captured video data into a predetermined or specified projection space (i.e. coordinate space) (215). The projection space may include equirectangular, spherical or cube map projection spaces. In the event that the captured video data is stitched into a non-cube map projection space, the non-cube map projection space is converted to a cube map projection space to generate cube mapped video data (220). In general, cube mapping is a method of mapping that uses the six faces of a cube as the map shape. In this instance, the captured video data is projected onto the sides of a cube and stored as six faces. The cube mapping is then unfolded in accordance with a predetermined or selected pixel or face arrangement (225). This is described further with respect to FIGS. 3 and 4 below. Application 130 generates mapping metadata that denotes the pixel arrangement and orientation. Application 130 can send the mapping metadata in a header file associated with the cube mapped video data, for example.

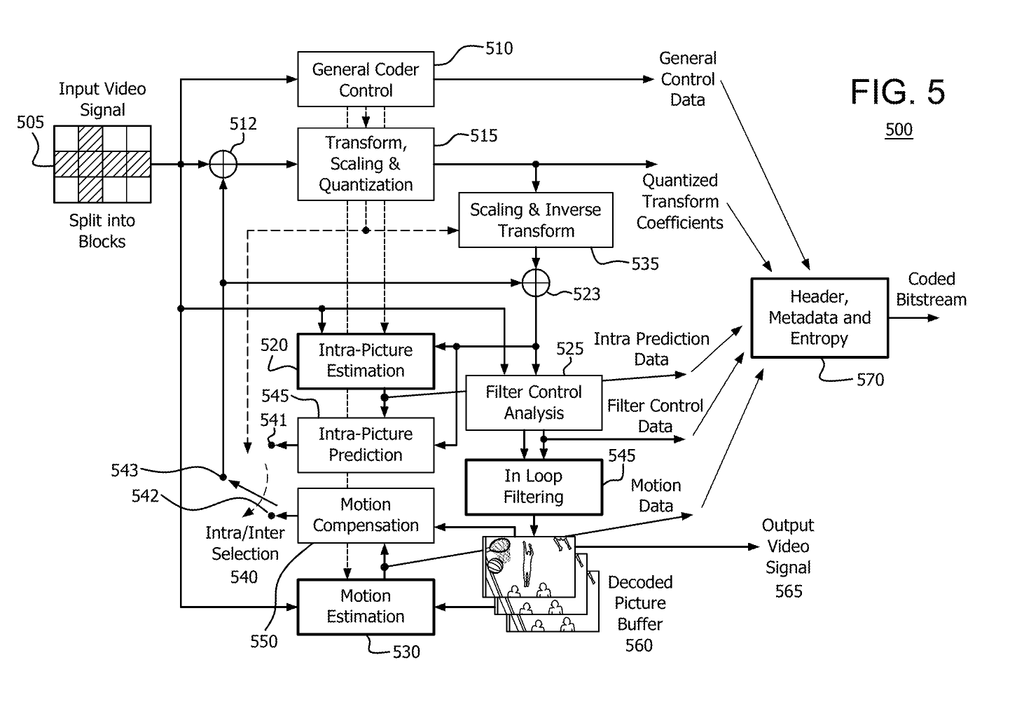

An encoder 135 uses the mapping metadata to encode the cube mapped video data (230). Encoder 135 can minimize the amount of video data that has to be read and stored, reduce the search region area, simplify transition smoothing between face edges and reduce the number of bits needed to encode specific faces. The impact of the mapping metadata is described further with respect to FIGS. 5, 6A-6C and 7A-7C. In an implementation, a multiplexor, (which may be integrated with encoder 135 or be a standalone device), multiplexes the encoded video data with audio data, for example (235). The encoded and/or multiplexed video data and mapping metadata is then stored for later use or transmitted via a network 105, for example, to a decoder 140 (240). In an implementation, a demultiplexor, (which may be integrated with decoder 140 or be a standalone device), demultiplexes the multiplexed video data from the audio data, for example (245). Decoder 140 decodes the (demultiplexed) encoded video data using the mapping metadata (250). An application 142, for example, then uses the mapping metadata to project the decoded cube mapped video data to a spherical space, for example (255). The video data is then sent to VR headset and audio headphones 146, for example (260).

FIGS. 3 and 4 are example diagrams of unfolding a cube mapping in accordance with certain implementations. As described above, the captured video data is projected onto the sides of a cube and stored as six faces. The size of each face is tied to the type of encoder being used. In general, encoders operate on video data in a predetermined block or macroblock (collectively “block”) size and video data is split by the encoder into multiples of these blocks. A block size can be 16×16 pixels, 64×64 pixels et cetera, for example. The size of each face should be an integer multiple of the encoder block size so that a block of the video data does not cross a face edge. In an implementation, the faces are square.

As noted, the cube mapping is unfolded in accordance with a predetermined or selected pixel arrangement. FIG. 3 illustrates a pixel arrangement where the cube mapping is unfolded in a “T’ configuration. In this configuration, the gray shaded faces, Left, Front, Right, Back, Top and Bottom represent actual mapped video data. A 4×3 rectangle is then formed that encircles the gray shaded faces and the non-shaded faces are identified as blank faces. FIG. 4 illustrates a pixel arrangement where the cube mapping is unfolded in a 2×3 rectangle with no blank faces. In this configuration, the faces represent the video data mapped to Left, Front, Right, Top, Bottom and Back. In these and other implementations, the mapping metadata would identify the pixel or face arrangement and orientation including which faces contain blank data. The encoder and decoder would apply the mapping metadata as described below with respect to FIGS. 5, 6A-6C and 7A-7C. FIGS. 3 and 4 show illustrative pixel arrangements and different pixel arrangements can be accomplished without departing from the scope of the claims There are many cube map formats that can be used, each having specific methods to optimize video encoders and/or decoders. The cube map formats described herein are illustrative.

FIG. 5 in an example diagram of an encoder 500 using cube mapped video data and mapping metadata in accordance with certain implementations. The diagram is illustrative and not all components are shown so as to focus on certain of the impacted components.

Encoder 500 includes an input port 505 that is in communication with or connected to (collectively “connected to”) at least a general coder control 510, a transform, scaling and quantization 515 via a summer 512, an intra-picture estimation 520, a filter control analysis 525, and a motion estimation 530. General coder control 510 is further connected to a header, metadata and entropy 570, transform, scaling and quantization 515 and motion estimation 530. Transform, scaling and quantization 515 is further connected to header, metadata and entropy 570, a scaling and inverse transform 535, an intra/inter selection 540. Intra-picture estimation 520 is further connected to header, metadata and entropy 570 and intra-prediction 545, which is in turn connected to a pole 541 of intra/inter selection 540.

Motion estimation 530 is further connected to header, metadata and entropy 570 and motion compensation 550, which is in turn connected to pole 542 of intra/inter selection 540. An output pole 543 of intra/inter selection 540 is connected to transform, scaling and quantization 515 via summer 512 and filter control analysis 525 via summer 523. Scaling and inverse transform 535 is further connected to filter control analysis 525 and intra-picture estimation 520, both via summer 523. Filter control analysis 525 is further connected to header, metadata and entropy 570 and in-loop filtering 555, which is in turn connected to decoded picture buffer 560. Decoded picture buffer 560 is further connected to motion estimation 530, motion compensation 550, and an output port 565 for outputting output video signal.

Operation of encoder 500 is described with respect to illustrative components that use mapping metadata to optimize encoder processing. In particular, these illustrative encoder components are motion estimation 530, intra-picture estimation 520, and in-loop filtering 555. Each of these encoder components implement logic that uses the mapping metadata to minimize or eliminate search regions when performing motion estimation, minimize or eliminate pixels when performing intra-picture estimation and assign zero weights to edges having no relational meaning when smoothing transition at face edges, i.e. deblocking. Other encoder components can also benefit directly or indirectly from the use of cube mapped video data and mapping metadata.

The cube mapped video data is input at input port 505. As stated above, encoder 500 splits the cube mapped video data into multiple blocks. The blocks are then processed by motion estimation 530, intra-picture estimation 520, and in-loop filtering 555 at the appropriate times using the mapping metadata.

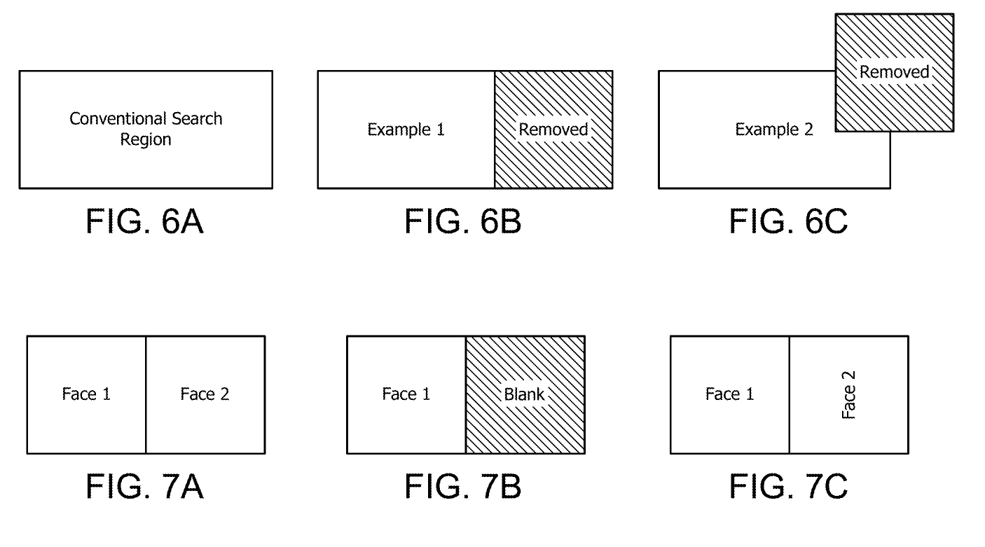

In general, motion estimation determines motion vectors that describe the transformation from one 2D image to another image from adjacent frames in the video data sequence. The motion vectors may relate to the whole image or specific parts, such as rectangular blocks, arbitrary shaped patches or even per pixel. In particular, motion estimation involves comparing each of the blocks with a corresponding block and its adjacent neighbors in a nearby frame of the video data, where the latter is denoted as a search area. A motion vector is created that models the movement of a block from one location to another. This movement, calculated for all the blocks comprising a frame, constitutes the motion on a per block basis estimated within a frame. For example, motion estimation is typically denoted by a vector X and vector Y that is the amount of motion in pixels in the x direction and in the y direction. Vectors X and Y can be fractions, such as ½ and ¼ depending on the codec in use. For a conventional encoder, a search area may have a height of 7 blocks, e.g., 3 blocks above and 3 blocks below a center block and a width that may be about twice the height. The search area parameters are illustrative and can depend on the encoder/decoder. A full search of all potential blocks however is a computationally expensive task. This search area is then moved in a predetermined manner from a target pixel, (i.e. right, left, up and down), in a search region as shown in FIG. 6A. Moreover, the number of blocks in a software encoder is usually variable and in a hardware encoder is usually fixed to a maximum number. The number of blocks can increases as the resolution increases.

Encoder 500 and motion estimation 530 minimizes the amount of cube mapped video data that has to be read and stored in cache and reduces the search region boundaries by using the mapping metadata. For example, in an implementation using a FIG. 3 type pixel arrangement, the mapping metadata can be used to identify which faces contain blank data, and which adjacent faces have no relational meaning (collectively “invalid regions”). For example, the mapping metadata can be used to identify the six faces that contain blank data in FIG. 3. In addition, the mapping metadata can be used to identify adjacent face pairings that have no relational meaning such as 1) the top face and bottom face, and 2) the top face and a blank. This can also be seen in FIG. 4, where the right face and the left face are not relationally meaningful when wrapping around from the right face to the left face. In some instances, the faces are rotationally incorrect. For example in FIG. 4, while a bottom to back edge does exist, the orientation of the faces is incorrect when the cube is unfolded since it is now a different edge.

In an implementation, encoder 500 and motion estimation 530 would not read or preload a cache or buffer for these invalid regions. In another implementation, motion estimation 530 could remove these invalid regions from the search region as shown for example in FIGS. 6B and 6C. That is, motion estimation 530 would not perform a motion search in the invalid region if the search area overlapped with the invalid region. In an implementation, rotational or orientation correction may be performed prior to motion search. In an implementation, a combination of the above techniques can be used.

In an implementation, removal or clamping of the search region can be done by generating a mask based on the mapping metadata, overlaying it on the search region and then search only in the remaining search region. In an implementation, a map can contain each pixel location along with an invalid bit or flag based on the mapping metadata. The map can then be used to not load data or skip regions as designated.

In intra-picture estimation 520, pixels in neighboring blocks are checked and potentially used to predict the pixels in the target block. Consequently, the efficiency of intra-picture estimation 520 can be increased by using the mapping metadata to eliminate searching in neighboring blocks that are invalid regions. Similar to motion estimation 530, intra-picture estimation 520 can proceed with the search if the faces are relationally meaningful as shown for example in FIG. 7A and can skip searching if the faces are not relationally meaningful as shown for example in FIG. 7B, (where Face 1 is adjacent to a blank face), and in FIG. 7C, (where Face 1 and Face 2 are rotationally incorrect). This can be implemented using the map described above, for example.

In-loop filtering 555 improves visual quality and prediction performance by smoothing the sharp edges which can form between blocks due to the block coding process. This is typically done by assigning a weight or strength to each horizontal and vertical edge between adjacent blocks. Based on the weight, a filter is applied across the edge to smooth the transition from one block to another block. A weight of zero means to do nothing on that edge. The efficiency of in-loop filtering 555 can be increased by using the mapping metadata to mark each edge with a zero that is not relationally meaningful. That is, the edge between two faces has no relational meaning. This can be implemented using the map described above, for example.

In addition to the above encoder components, encoder 500 can minimize the amount of bytes needed to encode the cubed mapped video data. In an implementation using a FIG. 3 type pixel arrangement, the mapping metadata can identify blank faces. These blank faces can be encoded as black, for example, and all subsequent neighbor blocks are intra-coded just like its prior neighbor. Other methods for encoding the blank region can be used to take advantage of the most efficient method for each encoder/decoder pair (codec) to encode a homogenous region. Consequently, this provides efficient encoding in terms of time and bits.

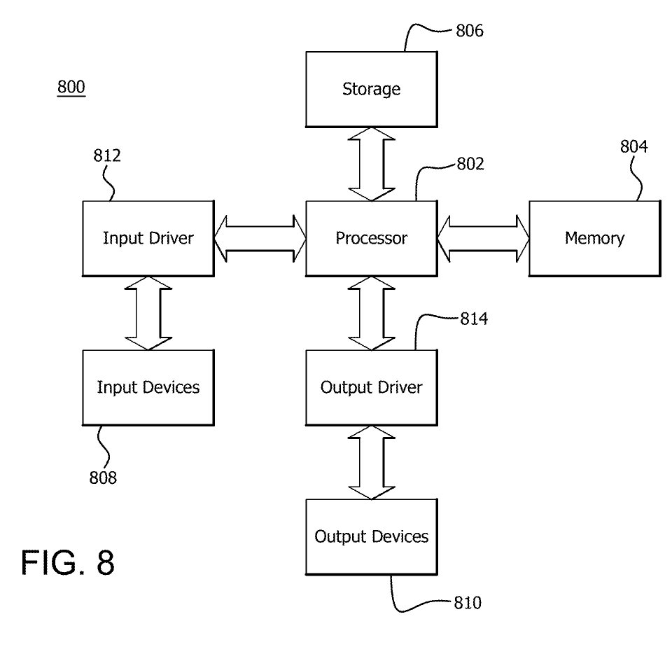

FIG. 8 is a block diagram of an example device 800 in which one or more features of the disclosure can be implemented. The device 800 can include, for example, a computer, a gaming device, a handheld device, a set-top box, a television, a mobile phone, or a tablet computer. The device 800 includes a processor 802, a memory 804, a storage 806, one or more input devices 808, and one or more output devices 810. The device 800 can also optionally include an input driver 812 and an output driver 814. It is understood that the device 800 can include additional components not shown in FIG. 8.

In various alternatives, the processor 802 includes a central processing unit (CPU), a graphics processing unit (GPU), a CPU and GPU located on the same die, or one or more processor cores, wherein each processor core can be a CPU or a GPU. In various alternatives, the memory 804 is be located on the same die as the processor 802, or is located separately from the processor 802. The memory 804 includes a volatile or non-volatile memory, for example, random access memory (RAM), dynamic RAM, or a cache.

The storage 806 includes a fixed or removable storage, for example, a hard disk drive, a solid state drive, an optical disk, or a flash drive. The input devices 808 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 810 include, without limitation, a display, a speaker, a printer, a haptic feedback device, one or more lights, an antenna, or a network connection (e.g., a wireless local area network card for transmission and/or reception of wireless IEEE 802 signals).

The input driver 812 communicates with the processor 802 and the input devices 808, and permits the processor 802 to receive input from the input devices 808. The output driver 814 communicates with the processor 802 and the output devices 810, and permits the processor 802 to send output to the output devices 810. It is noted that the input driver 812 and the output driver 814 are optional components, and that the device 800 will operate in the same manner if the input driver 812 and the output driver 814 are not present.

In general, a method for processing video data includes generating cube mapped video data, determining at least one pixel arrangement for the cube mapped video data, creating mapping metadata associated with the at least one pixel arrangement and encoding the cube mapped video data using the mapping metadata, where the mapping metadata provides pixel arrangement and orientation information. In an implementation, the mapping metadata is sent in a header associated with the cube mapped video data. In an implementation, the method includes converting non-cube mapped video data into the cube mapped video data. In an implementation, the mapping metadata identifies faces having blank data or faces that have no relational meaning with neighboring faces for use with motion estimation. In an implementation, the method further includes generating a mask based on the mapping metadata, overlaying the mask on the search region area to identify the faces having blank data or the faces that have no relational meaning with neighboring faces, and searching in remaining search region areas. In an implementation, the mapping metadata identifies faces having blank data or faces that have no relational meaning with neighboring faces for use with intra-picture estimation. In an implementation, the mapping metadata identifies face edges that have no relational meaning as between neighboring faces for transition smoothing between edge faces. In an implementation, the method further includes assigning a zero weight to a face edge when the face edge has no relational meaning as between neighboring faces. In an implementation, the mapping metadata identifies blank faces for purposes of storing the cube mapped.

In general, an apparatus for processing video data includes a video generator that generates cube mapped video data, determines at least one pixel arrangement for the cube mapped video data, creates mapping metadata associated with the at least one pixel arrangement and an encoder connected to the video generator, where the encoder encodes the cube mapped video data using the mapping metadata to minimize encoder processing by providing pixel arrangement and orientation information. In an implementation, the mapping metadata is sent in a header associated with the cube mapped video data. In an implementation, the video generator converts non-cube mapped video data into the cube mapped video data. In an implementation, the mapping metadata identifies faces having blank data or faces that have no relational meaning with neighboring faces for use in motion estimation. In an implementation, the encoder generates a mask based on the mapping metadata, overlays the mask on the search region area to identify the faces having blank data or the faces that have no relational meaning with neighboring faces and searches in remaining search region areas. In an implementation, the mapping metadata identifies faces having blank data or faces that have no relational meaning with neighboring faces for use in intra-picture estimation. In an implementation, the mapping metadata identifies face edges that have no relational meaning as between neighboring faces for use in transition smoothing between face edges. In an implementation, the encoder assigns a zero weight to a face edge when the face edge has no relational meaning as between neighboring faces. In an implementation, the mapping metadata identifies blank faces for the purpose of storing the cube mapped data.

A method for processing video data, the method including receiving cube mapped video data, receiving mapping metadata associated with at least one pixel arrangement for the cube mapped video data, and encoding the cube mapped video data using the mapping metadata, where the mapping metadata provides pixel arrangement and orientation information. In an implementation, the mapping metadata is received in a header associated with the cube mapped video data.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for processing video data, the method comprising:
generating cube mapped video data;
determining at least one pixel arrangement for the cube mapped video data;
creating mapping metadata associated with the at least one pixel arrangement; and
encoding the cube mapped video data using the mapping metadata, wherein the mapping metadata provides pixel arrangement and orientation information.

2. The method of claim 1, wherein the mapping metadata is sent in a header associated with the cube mapped video data.

3. The method of claim 1, wherein the generating the cube mapped video data includes converting non-cube mapped video data into the cube mapped video data.

4. The method of claim 1, wherein the mapping metadata identifies faces having blank data or faces that have no relational meaning with neighboring faces for use with motion estimation.

5. The method of claim 4, further comprising:
generating a mask based on the mapping metadata;
overlaying the mask on the search region area to identify the faces having blank data or the faces that have no relational meaning with neighboring faces; and
searching in remaining search region areas.

6. The method of claim 1, wherein the mapping metadata identifies faces having blank data or faces that have no relational meaning with neighboring faces for use with intra-picture estimation.

7. The method of claim 1, wherein the mapping metadata identifies face edges that have no relational meaning as between neighboring faces for transition smoothing between edge faces.

8. The method of claim 7, further comprising:
assigning a zero weight to a face edge when the face edge has no relational meaning as between neighboring faces.

9. The method of claim 1, wherein the mapping metadata identifies blank faces for purposes of storing the cube mapped.

10. An apparatus for processing video data, comprising:
a video generator that:
generates cube mapped video data;
determines at least one pixel arrangement for the cube mapped video data;
creates mapping metadata associated with the at least one pixel arrangement; and
an encoder connected to the video generator, the encoder:
encodes the cube mapped video data using the mapping metadata to minimize encoder processing by providing pixel arrangement and orientation information.

11. The apparatus of claim 10, wherein the mapping metadata is sent in a header associated with the cube mapped video data.

12. The apparatus of claim 10, wherein the video generator:
converts non-cube mapped video data into the cube mapped video data.

13. The apparatus of claim 1, wherein the mapping metadata identifies faces having blank data or faces that have no relational meaning with neighboring faces for use in motion estimation.

14. The apparatus of claim 4, wherein the encoder:
generates a mask based on the mapping metadata;
overlays the mask on the search region area to identify the faces having blank data or the faces that have no relational meaning with neighboring faces; and
searches in remaining search region areas.

15. The apparatus of claim 1, wherein the mapping metadata identifies faces having blank data or faces that have no relational meaning with neighboring faces for use in intra-picture estimation.

16. The apparatus of claim 1, wherein the mapping metadata identifies face edges that have no relational meaning as between neighboring faces for use in transition smoothing between face edges.

17. The apparatus of claim 7, wherein the encoder:
assigns a zero weight to a face edge when the face edge has no relational meaning as between neighboring faces.

18. The apparatus of claim 1, wherein the mapping metadata identifies blank faces for the purpose of storing the cube mapped data.

19. A method for processing video data, the method comprising:
receiving cube mapped video data;
receiving mapping metadata associated with at least one pixel arrangement for the cube mapped video data; and
encoding the cube mapped video data using the mapping metadata, wherein the mapping metadata provides pixel arrangement and orientation information.

20. The method of claim 19, wherein the mapping metadata is received in a header associated with the cube mapped video data.
